(19) United States
(12) Patent Application Publication
(10) Pub. No.: US 2011/0132931 A1
(43) Pub. Date: Jun. 9, 2011

(54) INTERACTIVE CHILDREN'S HAND SANITIZER

(76) Inventor: Shelley Lynn Wright, Martinsville, IN (US)

(21) Appl. No.: 12/632,570

(22) Filed: Dec. 7, 2009

(51) Int. Cl. B67D 7/84

(52) U.S. Cl. 222/173; 222/78; 222/190; 222/39

(57) ABSTRACT

A waterless hand sanitizer dispenser is disclosed which integrates the dispensing of waterless hand sanitizer into an interactive play environment, so that young children are not required to interrupt play to clean their hands, but instead are induced to clean their hands through the very act of engaging in play. In preferred embodiments, the dispenser includes a reservoir of waterless hand sanitizer, and an air compressor that is able to mix air with the sanitizer and create foam therefrom. The foam is integrated into an interchangeable interactive play environment such as imaginary snow, rain, or soap suds. In preferred embodiments, the toy dispenser is securely mounted to the surface of a tabletop or inside the clear sphere of a wonka embodiment, and the air compressor is manually-operable, pedal-operable, and/or mechanically driven. A far infrared sensor can be used to dispense the waterless hand sanitizer.

### FIELD OF THE INVENTION

The invention generally relates to devices used for hand sanitizing, and more specifically to dispensers of hand sanitizing solution.

### BACKGROUND OF THE INVENTION

Young children tend to explore the world with their hands, by touching everything they can reach. This presents a problem when a child is in a public place, such as a shopping mall, a health care facility, a pre-school or nursery school, or in any location where a parent or other responsible adult is not able to control the cleanliness of the environment.

Frequent washing of a child's hands is one of the most effective methods for preventing a child from contracting a disease due to hand-contact with germ-contaminated walls, hand-rails, and other objects and structures. However, it can be difficult and/or time-consuming to locate a bathroom or other washing facility in a public place so as to clean a child's hands. Furthermore, due to poorly designed or improperly functioning equipment, public washing facilities can harbor more germs than expected and even present the risk of compromising one's hygiene rather than enhancing it. Also, many young children do not find hand washing particularly enjoyable, and may resist efforts to make them wash their hands frequently. Even at home, a child may not wish to stop what he or she is doing just to wash his or her hands. For example, the child may not feel the need or desire to wash his or her hands, simply because the child has sneezed, coughed or blown their nose, or because it's time to eat.

One approach is to use a waterless hand sanitizer, which can clean and disinfect the hands of a young child without the need to find a source of water, towels, etc. A parent can carry a portable supply of hand sanitizer, and/or a dispenser can be provided at strategic locations in a public place. For locations that are frequented by children, such as pre-schools, daycares, pediatric health care facilities, malls, restaurants with indoor playgrounds, and such like, waterless hand sanitizer dispensers can be provided that include shapes, colors, and other features that have appeal for young children. In some approaches, hand sanitizer dispensers are able to make sounds, play music, and play recorded speech when they are used. In some of these approaches, educational information is also provided, such as information regarding proper hand sanitization methods.

Nevertheless, all of these approaches require that a young child interrupt their play so as to sanitize their hands. While interesting shapes, colors, and sounds can make this more palatable to the child, there is no substitute for play activities that a child may wish to engage in. As a result, a child will typically not be motivated to interrupt their play to sanitize his or her hands with the methods described above, unless and until a responsible tells them to do so.

### SUMMARY OF THE INVENTION

A waterless hand sanitizer dispenser is claimed that integrates dispensing of hand sanitizer, preferably an all natural, F.D.A approved antimicrobial hand sanitizer or an alcohol-based hand sanitizer, into an interactive thematic play environment, so that a young child is not required to interrupt play to clean his or her hands, but instead is induced to clean his or her hands through the very act of engaging in play. The invention will therefore encourage children to clean their hands more frequently, and in preferred embodiments where the hand sanitizer in use is alcohol-based sanitizer, the invention will result in children using alcohol-based sanitizer more frequently, which studies have shown may reduce respiratory illness transmission among family members in the homes of children enrolled in child care.

In preferred embodiments, the waterless hand sanitizer dispenser of the present invention includes a table, a reservoir of waterless hand sanitizer, and an air compressor that is able to mix air with the hand sanitizer and create sanitizer foam therefrom. In alternative embodiments the dispenser can include a source of pressurized air. The foam is then integrated into an interactive play environment, which in preferred embodiments is implemented on the surface of a tabletop, for public use for example. In alternative embodiments, the interactive play environment can be implemented in other ways for private use, such as upon a shallow bowl or mat with a raised edge. In some preferred embodiments, the source of compressed air is a manually operable air pump.

In preferred embodiments, the tabletop is exchangeable, thereby allowing the dispenser to provide multiple, exchangeable interactive play environments. Examples of interactive play environments include a volcano with hand sanitizer foam serving as lava, a car wash with hand sanitizer foam serving as car washing soap, a world globe with hand sanitizer foam serving as “snow” falling on the continents, and a “wonka” that provides interesting tubes and passages for the hand sanitizer foam, and possibly other objects such as marbles, to flow through the tubes as the foam is dispensed.

In one embodiment, the invention is a waterless hand sanitizer dispenser with integrated children's interactive play environment to encourage use of waterless hand sanitizer, the waterless hand sanitizer dispenser comprising a reservoir that is able to contain a supply of waterless hand sanitizer, and a dispenser integrated within an interactive play environment, the dispenser being able to dispense waterless hand sanitizer from the reservoir into the interactive play environment in a manner that causes the waterless hand sanitizer to integrate thematically with the interactive play environment, thereby encouraging a user to use the waterless hand sanitizer via the interactive play environment.

In other embodiments, the waterless hand sanitizer dispenser further comprises an air compressor that is able to mix air with the waterless hand sanitizer, thereby causing the waterless hand sanitizer to be dispensed as foam. In some of these embodiments, the air compressor is air pump with an electric motor powered by connection to a wall outlet, an air pump with an electric motor powered by at least one battery, an air pump adapted to be driven by a manually-operable handle, an air pump adapted to be driven by a foot-operable pedal, and/or an air pump to be adapted to be activated by the use of a far infrared sensor. In some of these embodiments, the invention further comprises a source of compressed air that is adapted to be mixed with the waterless hand sanitizer, thereby causing the waterless hand sanitizer to be dispensed as foam. In some other embodiments, the waterless hand sanitizer is a liquid or a gel.

In some embodiments of the invention, the interactive play environment is mounted on a shallow bowl, on a mat with a raised edge running along at least a portion of its perimeter, or on a table-top.

In some of these embodiments, the interactive play environment mounted on a table-top is interchangeable with other interactive play environments.
In some other embodiments, the table-top is interchangeable with a plurality of other table-tops, wherein each table-top includes a different interactive play environment.
In some embodiments, each table-top includes a compartment door for facilitating the interchanging of different table-tops, and/or the refilling of waterless hand sanitizer.

In some embodiments, the interactive play environment is an elephant, with waterless hand sanitizer being dispensable as imaginary water from the elephant's trunk; a water setting, with waterless hand sanitizer being dispensable into an imaginary body of water; a witch's cauldron, with waterless hand sanitizer being dispensable as imaginary brew from the cauldron; a volcano, with waterless hand sanitizer being dispensable as imaginary lava; a car wash, with waterless hand sanitizer being dispensable as imaginary car washing soap; a world globe, with waterless hand sanitizer being dispensable as imaginary precipitation; or a wonka, the waterless hand sanitizer being dispensable into channels that direct the dispensed hand sanitizer in at least one pathway.

In some embodiments, the invention further comprises a sound-producing system that is able to produce audible output of interest to children.

In some of these embodiments, the sound-producing system is able to play music, or produce interesting sounds. In some of these embodiments, the sound-producing system is able to provide sounds that integrate thematically with the interactive play environment. In some of these embodiments, the sound-producing system is able to provide educational information that is thematically relevant to the interactive play environment.

### BRIEF DESCRIPTION OF THE DRAWINGS

The invention will be more fully understood by reference to the detailed description, in conjunction with the following figures, wherein:

FIG. 1 is a perspective view of a possible embodiment of an interactive waterless hand sanitizer dispenser assembly, showing a child engaged with a waterless hand sanitizer dispenser including an elephant standing on a shallow bowl on its hind legs;

FIG. 2 is a perspective view of an alternate embodiment of the interactive waterless hand sanitizer dispenser assembly, showing a child engaged with a waterless hand sanitizer dispenser including a shallow bowl with at least one fish and a rock wall;

FIG. 3 is a perspective view of a waterless hand sanitizer dispenser assembly mounted to a support table;

FIG. 4 is a perspective view of a preferred embodiment of the interactive waterless hand sanitizer dispenser assembly, showing a child engaged with a waterless hand sanitizer dispenser including a toy volcano;

FIG. 5 is a perspective view of another preferred embodiment of the interactive waterless hand sanitizer dispenser assembly, showing a child engaged with a waterless hand sanitizer dispenser assembly including a toy car wash;

FIG. 6 is a perspective view of another a preferred embodiment of the interactive waterless hand sanitizer dispenser assembly, showing a waterless hand sanitizer dispenser including a world globe; and

FIG. 7 is a front view of yet another preferred embodiment of the interactive waterless hand sanitizer dispenser assembly, showing a waterless hand sanitizer dispenser including a wonka.

### DETAILED DESCRIPTION OF PREFERRED EMBODIMENTS

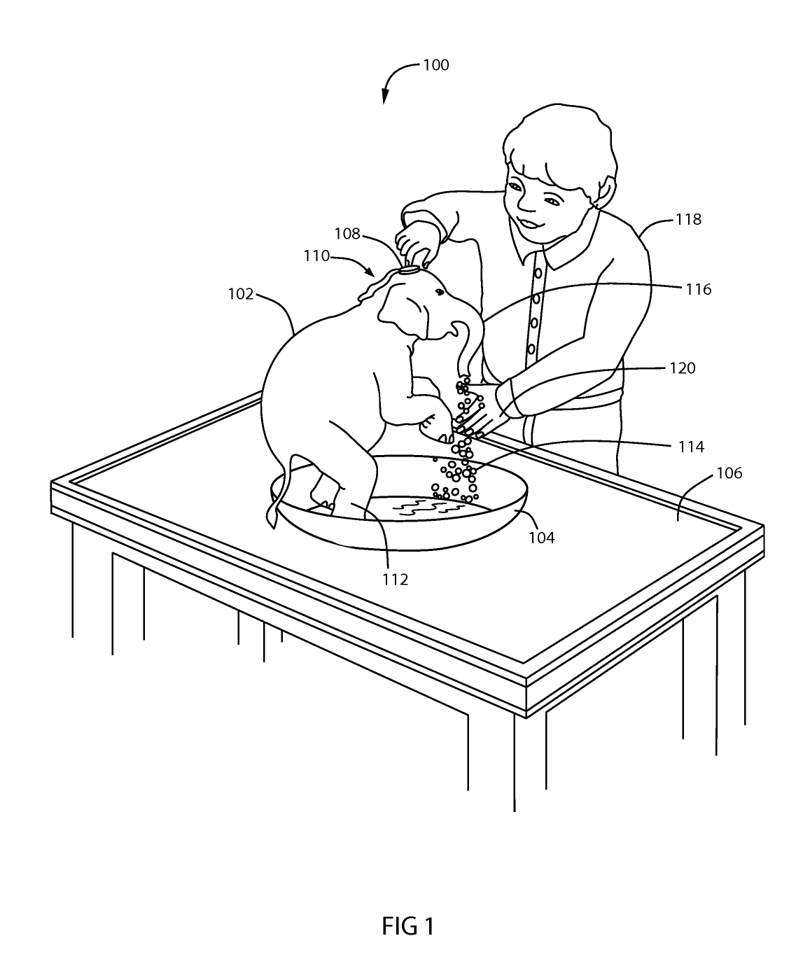

The invention is a waterless hand sanitizer dispenser which delivers an anti-microbial sanitizing composition to a user through an interactive play theme environment, of which the anti-microbial sanitizing composition is an integral part. As used in this application, “waterless hand sanitizer” refers to the fact that the anti-microbial sanitizing composition dispensed from the dispenser does not require a user to mix the composition with a separate source of water. With reference to FIG. 1, an interactive waterless hand sanitizer dispenser assembly 100 showing an elephant 102 reared up on its hind legs 112 on a shallow bowl 104 is mounted on a table-top 106. A button 108 fixed near the back of the head of the elephant 110 can be pressed to dispense a waterless hand sanitizer as foam 114 from a trunk of the elephant 116. As used here and elsewhere in the application, foam refers to compositions of liquid or gel mixed with a gas, such as an aerosol propellant and/or ambient air, to form a semi-structured composition or mass comprising bubbles of gas trapped within a liquid or gel matrix. When a child 118 presses the button 108 positioned on the back of the head of the elephant 110, the waterless hand sanitizer dispensing as foam 114 from the trunk 116 can be used to clean and disinfect hands of the at least one child 120. In preferred embodiments, the dispenser is pressure activated. The pressing of the button activates dispensing of the waterless hand sanitizer. The trunk of the elephant 116 is oriented downwards so as to collect the waterless hand sanitizer dispensed as foam 114 into the shallow bowl 104. The embodiment illustrated in FIG. 1 can also be smaller, for even more personalized use. In alternative embodiments, the sanitizer can collect on a mat with a raised or lipped edge, or some other repository instead of the shallow bowl 104. Other analogous embodiments will occur to those of ordinary skill in the art.

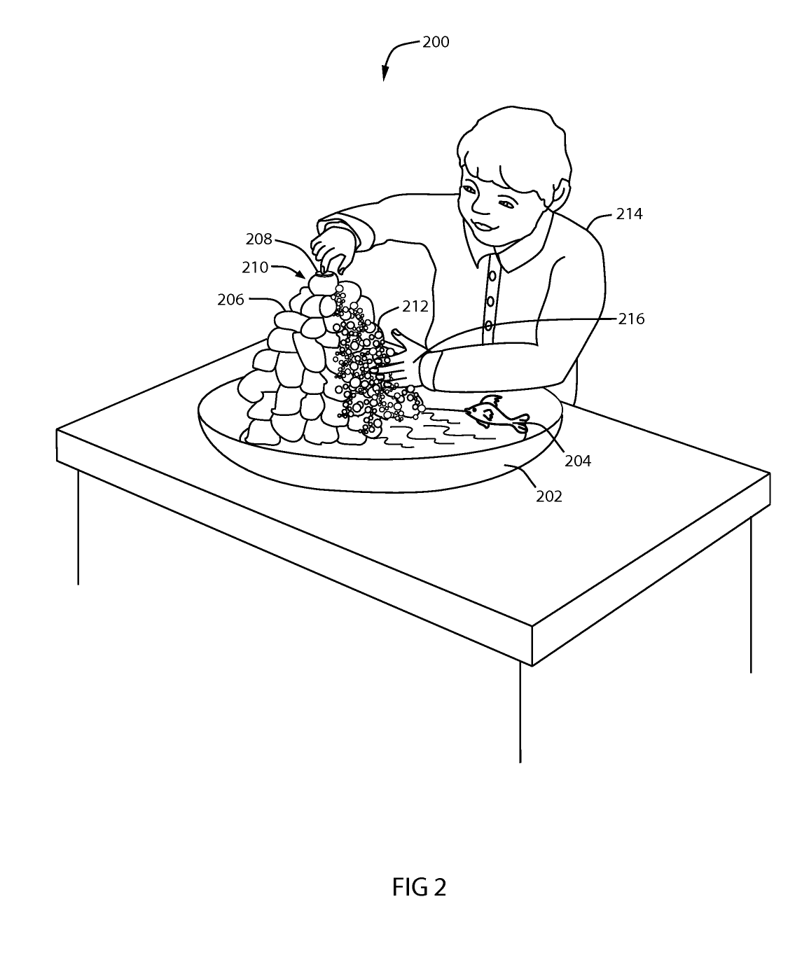

FIG. 2 is a perspective view of another preferred embodiment of an interactive waterless hand sanitizer dispenser assembly 200. In the embodiment shown, the waterless hand sanitizer dispenser is resting on a countertop instead of a tabletop. The interactive waterless hand sanitizer dispenser assembly 200 includes a shallow bowl 202 with at least one fish 204 and a rock wall 206. A button 208 positioned on a top of the rock wall 210 dispenses the waterless hand sanitizer dispenser as foam in the form of a waterfall 212. At least one child 214 can disinfect their hands 216 with the waterfall 212 from the rock wall 206 by playing with the waterfall 212. The foam dispensed as waterfall 212 can be collected into the shallow bowl 202.

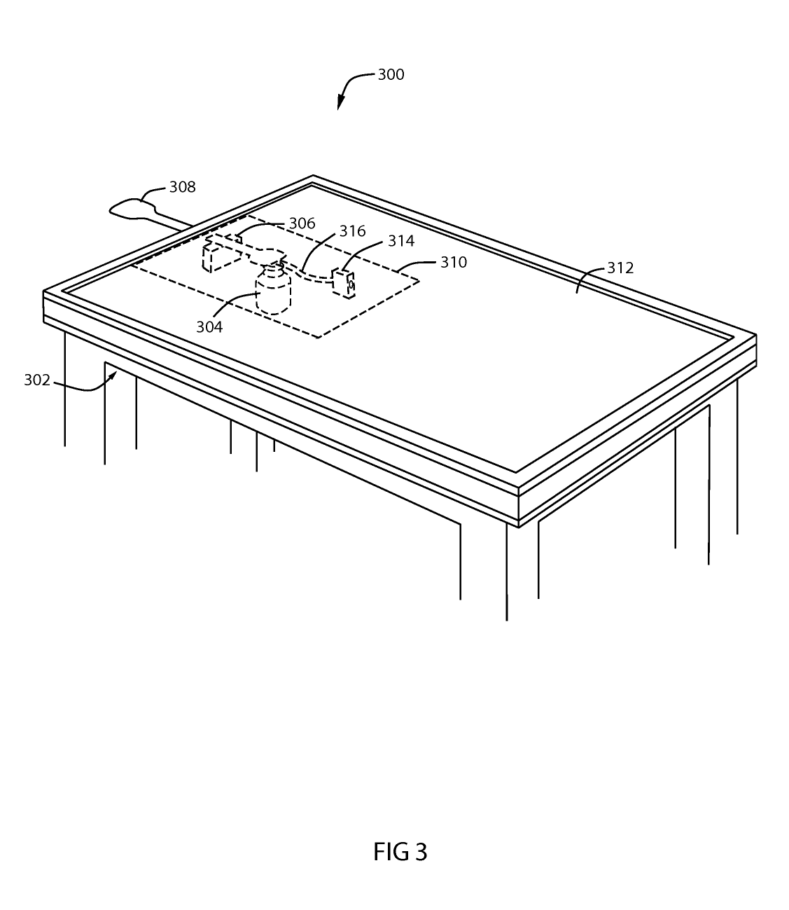

FIG. 3 shows a perspective view of a waterless hand sanitizer dispenser assembly 300 that can be mounted to a support table 302. The waterless hand sanitizer dispenser assembly 300 includes at least one reservoir 304 containing a supply of waterless hand sanitizer and a dispenser for dispensing the waterless hand sanitizer from the reservoir 304. The waterless hand sanitizer dispenser assembly 300 further comprises an air compressor to mix air with the waterless hand sanitizer to be dispensed as foam. In the embodiment shown, a paddle 308 is connected to the dispenser. When the paddle 308 is moved up and down, the air pump mixes the waterless hand sanitizer with compressed air from an air source such as ambient air, and foam is dispensed. In some preferred embodiments, the paddle can be spring loaded, to improve its function. The use of a far infrared sensor is also contemplated. In the exemplary embodiment shown, the waterless hand sanitizer dispenser assembly 300 further comprises a sound-producing system 306 to produce audible output of interest. The sound producing system 306 can be adapted to produce interesting audible output when the waterless hand sanitizer dispenser assembly 300 is in use, for example by including a switch which is activated during operation of the waterless hand sanitizer dispenser assembly 300. The air compressor shown in this embodiment is an air pump driven by a paddle 308. Alternatively, the waterless hand sanitizer dispenser can include a separate source of compressed air, such as a CO2 cartridge. In preferred embodiments, the waterless hand sanitizer dispenser assembly 300 can be placed on a shelf within the support table 302, or mounted to the support table. This compartment 310 would have a compartment door on the surface 312 for ease of interchangeability and sanitizer refill. In some embodiments, the waterless hand sanitizer dispenser assembly 300 can further include extra storage of hand sanitizer, and/or compressed air, in drawers underneath the support table 302 for example.

The waterless hand sanitizer dispenser is adapted so as to be integrated within at least one interactive play environment, not shown in this figure. The dispenser dispenses the waterless hand sanitizer into the at least one interactive play environment in a manner that causes the waterless hand sanitizer to serve as an integral thematic component of the at least one interactive play environment. The interactive play environment can be a centerpiece toy. In some preferred embodiments, the interactive play centerpiece, i.e. the volcano or the globe can be mounted on at least one exchangeable table-top 312. In other embodiments, the interactive play centerpiece mounted on a given table-top can be interchangeable with other interactive play centerpieces. A plurality of exchangeable table-tops are included, each of the at least one exchangeable table-top having the at least one interactive play environment mounted thereon. The at least one interactive play environment may be one of a volcano, a car wash, a world globe, a water setting or a “wonka,” for example. The exchangeable table-top 312 can be fitted onto the support table 302 and secured thereon, by means of a lip around the perimeter of the table, which extends down the sides of the support table. In alternative embodiments, the support table 302 can include a set of clamps to clamp the table-top 312 to the support table 302.

The table-top 312 can come in a variety of sizes, shapes and materials. For example, the table-top 312 can be a rectangular or circular table that is sufficiently large for public use, or for use by multiple children. Alternatively the table-top 312 can be a more personal size, for personal use by one child at a time. The table-top 312 can be made from a variety of materials, including plastic or wood that may or may not have incorporated antimicrobial preservatives approved by the E.P.A. The support table 302 can be of an appropriate size, shape, and consistency, so as to sufficiently support the table-top 312.

A conduit is shown leading from the reservoir 304 to an area underneath the middle of the table-top. A quick-disconnect is also shown, which enables interactive play environments with their own hosing to be easily interchanged and secured to the conduit. The waterless hand sanitizer can be pumped through the conduit and further into the hosing of a given interactive play environment, where it is driven upwards through the center of an interactive play toy, for example.

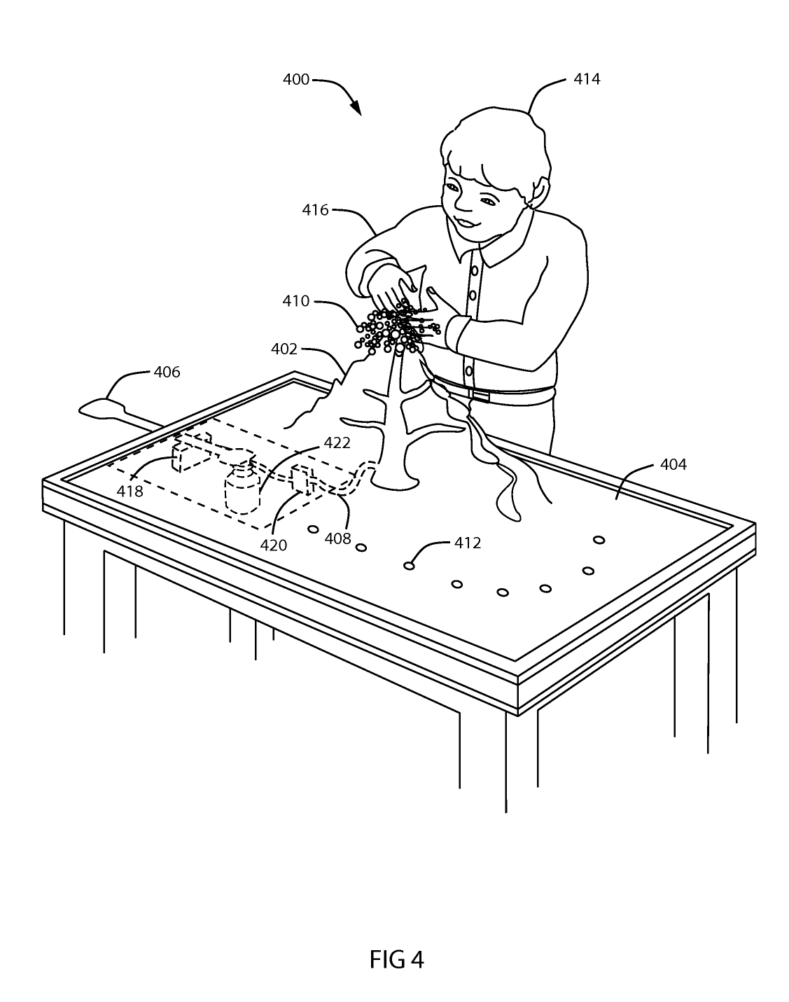

FIG. 4 shows another embodiment of an interactive waterless hand sanitizer dispenser assembly 400 showing a volcano 402 mounted on at least one exchangeable table-top 404. A paddle 406 is connected to the dispenser. When the paddle 406 is moved up and down, the air pump mixes the waterless hand sanitizer with compressed air from an air source, creating foam. The foam is dispensed through a conduit 408 to the interior of the volcano 402, and dispensed out the top of the volcano as imaginary volcano lava 410. A plurality of holes 412 is provided on the exchangeable table-top 404, for draining off the dispensed lava 410. At least one child 414 can play with the volcano waterless hand sanitizer dispenser assembly 400, for example by rubbing hands 416 with the lava 410 and thereby cleaning and disinfecting their hands 416. A sound producing system 418 can be included, providing sound effects or information related to the importance of cleaning hands, for example. The sound producing system 418 can also provide sound effects and/or information about volcanoes.

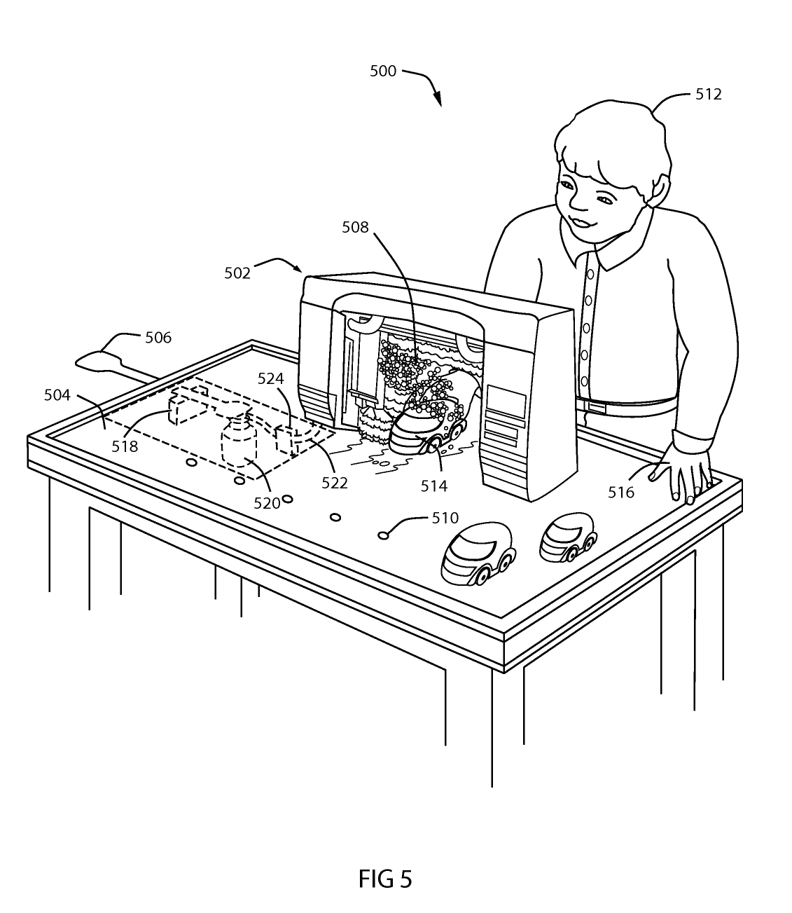

FIG. 5 is a perspective view of yet another embodiment of an interactive waterless hand sanitizer dispenser assembly 500 showing a toy car wash 502 mounted on an exchangeable table-top 504. A paddle 506 is connected to the dispenser. When the paddle 506 is moved up and down, the air pump mixes the waterless hand sanitizer with compressed air from an air source, and the foam is dispensed as a car washing soap 508. The foam can be delivered through internal hosing inside the car wash toy, for example. A plurality of holes 510 on the at least one exchangeable table-top 504 drains off the imaginary car washing soap 508 dispensed thereof. When at least one child 512 pushes at least one car 514 through the car wash 502, the car washing soap 508 cleans and disinfects the child's hands 516. A sound producing system 518 can produce audible output of interest that may include entertaining or educational information. The sound producing system 518 can play music and/or produce interesting noises and/or sounds which relate to hand washing, and/or integrate thematically with the at least one interactive play environment 500.

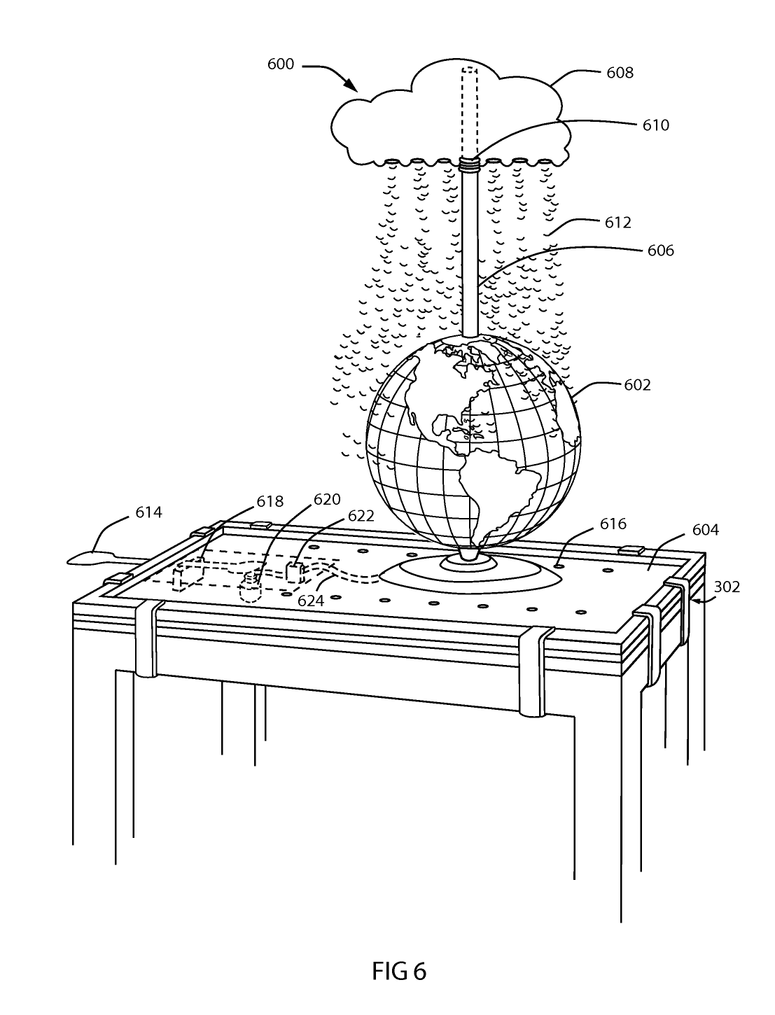

FIG. 6 shows a perspective view of alternate embodiment of an interactive waterless hand sanitizer dispenser 600 illustrating a world globe 602 mounted on at least one exchangeable table-top 604. In this embodiment, clamps are used to secure the table-top 604 to the support table 302. As shown in the figure, a rigid pole 606 with a hollow tubular interior passes through a middle axis of the world globe 602 and extends to a cloud 608. The pole 606 can be fixed to the flat cloud 608 by a securing device 610, such as a washer. Compressed air from an air source is mixed with waterless hand sanitizer, and passes upwards through the pole 606 and into the cloud 608. From inside the cloud 608, the waterless hand sanitizer is dispensed as imaginary precipitation 612 by moving a paddle 614. In the embodiment shown, the precipitation 612 is in the preferred form of rain or snow falling over the world globe 602. The globe can be rotated around its axis to simulate planetary rotation, for example by driving the central pole 606 rotationally with a motor. At least one child can clean and disinfect their hands while playing with the sanitizer in the form of precipitation 612. The precipitation 612 dispensed thereof is drained through a plurality of holes 616 provided on the at least one exchangeable table-top 604, and collected at the shelf located below the support table 302. A sound producing system 618 may produce educational information about geography of different continents, climates and the like. The sound producing system 618 is able to provide educational information that is thematically relevant to the at least one interactive play environment 600. The sound producing system 618 can also provide information or other audio output relevant to hand washing, and/or the importance of keeping hands clean.

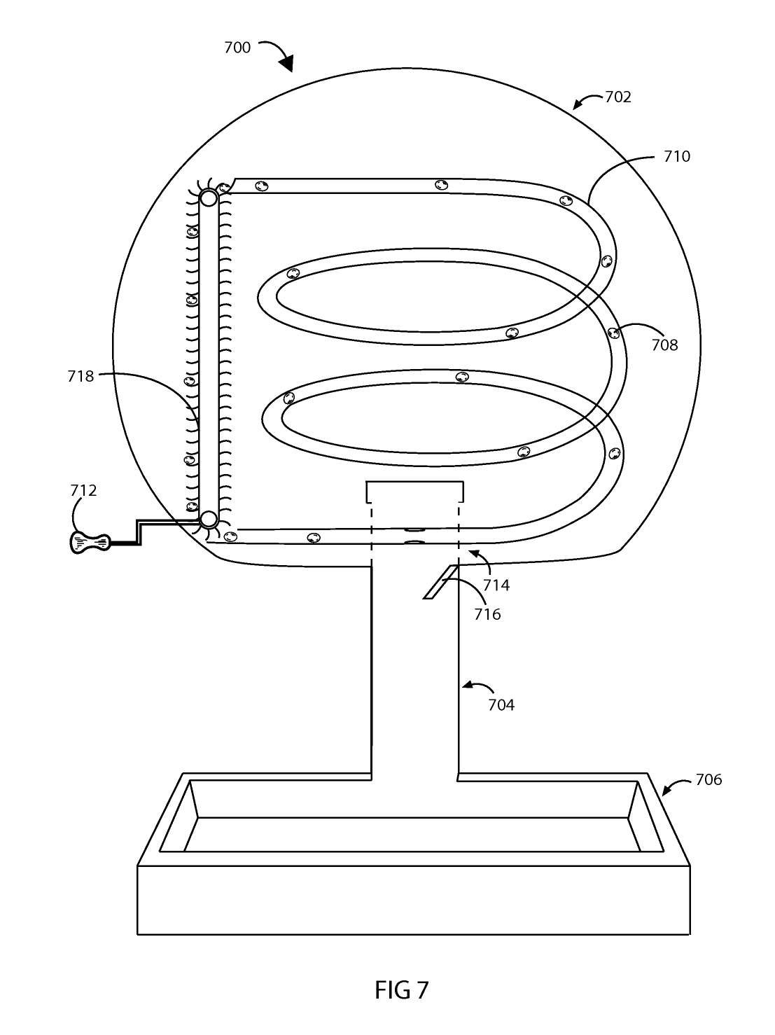

FIG. 7 illustrates a front view of another alternate embodiment of an interactive waterless hand sanitizer dispenser 700. A “wonka” version of the interactive play environment 700 includes a clear spherical housing 702, supported by a stand 704. The stand is supported by a base 706 with a lip around its edge. The clear spherical housing, may house one of a plurality of interactive environments that contain their own tubing for entertaining and dispensing sanitizer such as; the volcano centerpiece referred to in FIG. 4 for the tables, the carwash FIG. 5 with a descending track for the cars to race on, even a glacier for “weeble wobble” type characters i.e. penguins to slide down a descending track or as shown in FIG. 7, a plurality of marbles 708 running around at least one track 710. The marbles 708 run around the at least one track 710 when a hand-crank 712 is turned. The at least one track 710 passes under the reservoir 714 containing a supply of waterless hand sanitizer, and when the marbles 708 pass under the portion of the at least one reservoir 714, they can activate a switch which then dispenses a small quantity of the waterless hand sanitizer. The switch can be a mechanical, electrical or far infrared sensor, for example. When a child places their hands near the door of the wonka version of the interactive play environment 716, the small quantity of waterless hand sanitizer dispensed cleans and disinfects the child's hands. The marbles 708 may have bells or whistles producing musical sounds for entertaining children when the marbles 708 run around the track system 710. After descending their track, the marbles are propelled back up the marble elevator #718.

The invention claimed in its broadest embodiment is a waterless hand sanitizer dispenser. The detailed description has discussed a manually driven waterless hand sanitizer dispenser assembly, using a paddle or crank as the drive mechanism. Other embodiments will be readily apparent to one skilled in the art. For example, the waterless hand sanitizer dispenser assembly can be pedal operated or use a far infrared sensor as contemplated. In other preferred embodiments, the assembly can be driven through the use of a pneumatic or hydraulic pump. The assembly can use an air compressor to mix ambient air with a source of sanitizer, and/or a separate store of compressed air may be used to deliver the air, such as a CO2 cartridge.

Various different play themes have been described herein. Many other play themes within the scope of the claimed invention can be contemplated. As one example, the play theme can be a witch's brew scene. In such an embodiment, waterless hand sanitizer can be integrated into the witch's brew scene as imaginary witch's brew, issuing forth from a witch's cauldron for example.

Other modifications and implementations of various aspects of the invention will occur to those skilled in the art without departing from the spirit and the scope of the invention as claimed. Accordingly, the above description is not intended to limit the invention except as indicated in the following claims.

What is claimed is:

1. A waterless hand sanitizer dispenser with integrated children's interactive play environment to encourage use of waterless hand sanitizer, the waterless hand sanitizer dispenser comprising:
a reservoir that is able to contain a supply of waterless hand sanitizer; and
a dispenser integrated within an interactive play environment, the dispenser being able to dispense waterless hand sanitizer from the reservoir into the interactive play environment in a manner that causes the waterless hand sanitizer to integrate thematically with the interactive play environment, thereby encouraging a user to use the waterless hand sanitizer via the interactive play environment.

2. The waterless hand sanitizer dispenser of claim 1, further comprising an air compressor that is able to mix air with the waterless hand sanitizer, thereby causing the waterless hand sanitizer to be dispensed as foam.

3. The waterless hand sanitizer dispenser of claim 2, wherein the air compressor is one of:
an air pump with an electric motor powered by connection to a wall outlet;
an air pump with an electric motor powered by at least one battery;
an air pump adapted to be driven by a manually-operable handle;
an air pump adapted to be driven by a foot-operable pedal; and
an air pump to be adapted to be activated by the use of a far infrared sensor.

4. The waterless hand sanitizer dispenser of claim 1, further comprising a source of compressed air that is adapted to be mixed with the waterless hand sanitizer, thereby causing the waterless hand sanitizer to be dispensed as foam.

5. The waterless hand sanitizer dispenser of claim 1, wherein the waterless hand sanitizer is one of:
a liquid; and
a gel.

6. The waterless hand sanitizer dispenser of claim 1, wherein the interactive play environment is mounted on a shallow bowl.

7. The waterless hand sanitizer dispenser of claim 1, wherein the interactive play environment is mounted on a mat with a raised edge running along at least a portion of its perimeter.

8. The waterless hand sanitizer dispenser of claim 1, wherein the interactive play environment is mounted on a table-top.

9. The waterless hand sanitizer dispenser of claim 8, wherein the interactive play environment mounted on a table-top is interchangeable with other interactive play environments.

10. The waterless hand sanitizer dispenser of claim 8, wherein the table-top is interchangeable with a plurality of other table-tops, wherein each table-top includes a different interactive play environment.

11. The waterless hand sanitizer dispenser of claim 10, wherein each table-top of the plurality of table-tops includes a compartment door for facilitating at least one of:
interchanging of different table-tops, and
refilling of waterless hand sanitizer.

12. The waterless hand sanitizer dispenser of claim 1, wherein the interactive play environment is one of:
an elephant, the waterless hand sanitizer being dispensable as imaginary water from the elephant's trunk;
a water setting, the waterless hand sanitizer being dispensable into an imaginary body of water;
a witch's cauldron, the waterless hand sanitizer being dispensable as imaginary brew from the cauldron;
a volcano, the waterless hand sanitizer being dispensable as imaginary lava;
a car wash, the waterless hand sanitizer being dispensable as imaginary car washing soap;
a world globe, the waterless hand sanitizer being dispensable as imaginary precipitation; and
a wonka, the waterless hand sanitizer being dispensable into channels that direct the dispensed hand sanitizer in at least one pathway.

13. The waterless hand sanitizer dispenser of claim 1, further comprising a sound-producing system that is able to produce audible output of interest to children.

14. The waterless hand sanitizer dispenser of claim 13, wherein the sound-producing system is able to play music.

15. The waterless hand sanitizer dispenser of claim 13, wherein the sound-producing system is able to produce interesting sounds.

16. The waterless hand sanitizer dispenser of claim 15, wherein the sound-producing system is able to provide sounds that integrate thematically with the interactive play environment.

17. The waterless hand sanitizer dispenser of claim 13, wherein the sound-producing system is able to provide educational information that is thematically relevant to the interactive play environment.
